(19) United States
(12) Patent Application Publication
(10) Pub. No.: US 2005/0274025 A1
(43) Pub. Date: Dec. 15, 2005

(54) Scissors with adjustable cutting sectional angle

(76) Inventor: Pei-Yun Lin, Chang Hua Hsien (TW)

Correspondence Address: CHARLES E. BAXLEY, ESQ., 90 JOHN STREET, THIRD FLOOR, NEW YORK, NY, 10038, US

(21) Appl. No.: 10/868,280

(22) Filed: Jun. 14, 2004

(51) Int. Cl. B26B 17/00

(52) U.S. Cl. 30/177; 30/178; 30/233; 30/229

(57) ABSTRACT

The present invention discloses a pair of scissors with adjustable cutting sectional angle which comprises a first limb and a second limb being pivotally connected and capable of being extended or engaged, a blade disposed at the front end of the first limb; and the pair of scissors further comprises a rotary disc base being disposed at the front end of the second limb for cutting a work piece; a rotary axle disposed at a central line of the rotary disc base and having two blocking brackets protruded from its top, and a through channel disposed at the middle of the two blocking brackets for allowing the pair of scissors to pass through; such that users can rotate the rotary disc axle to adjust the angle of the blocking bracket and the blade in order to control the cutting angle of the work piece.

### BACKGROUND OF THE INVENTION

1. Field of the Invention

The present invention relates to scissors, more particularly to a pair of scissors capable of adjusting and controlling the cutting sectional angle of a work piece.

2. Description of the Related Art

In general, a pair of scissors comprises two cross connected limbs that can be elastically extended or engaged, a blade section disposed at the front end of each of the two limbs for cutting and a handle section disposed at the other end for holding. Users can apply a gripping force to engage the two blade sections for a shear action, so that a linear cutting surface is produced for the work piece.

However, the prior-art scissors only focus on the direct shear of the work piece, but do not have the function of adjusting the cutting sectional angle of the work piece. The cutting angle for scissors is usually controlled by the user's personal experience or judgment or by marking a line and using some other measuring tools to measure the angle of the desired work piece before cutting the work piece according to the marked line. Such arrangement not only involves a series of complicated procedures, but also wastes lots of time on measuring the same angle and marking the line on a large quantity of work pieces.

### SUMMARY OF THE INVENTION

The primary objective of the present invention is to provide a pair of scissors with adjustable cutting sectional angle, such that a user can rotate a disc axle to adjust a blocking bracket and the angle between two blades in order to control the cutting sectional angle of a work piece. The user can push the work piece all the way to the blocking bracket and apply a force individually onto a first limb and a second limb to drive the blade to cut from the through channel and the work piece at a desired angle.

The technical measures taken by the invention to overcome the shortcomings of the prior art are described as follows. A pair of scissors with adjustable cutting sectional angle comprises a first limb and a second limb being pivotally connected and capable of being extended or engaged, a blade disposed at the front end of the first limb; and the pair of scissors further comprises a rotary disc base being disposed at the front end of the second limb for cutting a work piece; a rotary axle disposed at a central line of the rotary disc base and having two blocking brackets protruded from its top, and a through channel disposed at the middle of the two blocking brackets for allowing the pair of scissors to pass through.

### BRIEF DESCRIPTION OF THE DRAWINGS

FIG. 1 is an exploded view of the pair of scissors with adjustable cutting sectional angle according to the present invention.

FIG. 2 is a perspective view of the pair of scissors with adjustable cutting sectional angle according to the present invention.

FIG. 3 is a cross-sectional view of the rotary disc base according to the present invention.

FIG. 4 is a planar view of the rotary disc base according to the present invention.

FIG. 5 is an illustrative view of the motion of the rotary disc axle according to the present invention.

FIG. 6 is another illustrative view of the motion of the rotary disc axle according to the present invention.

### DETAILED DESCRIPTION OF THE PREFERRED EMBODIMENTS

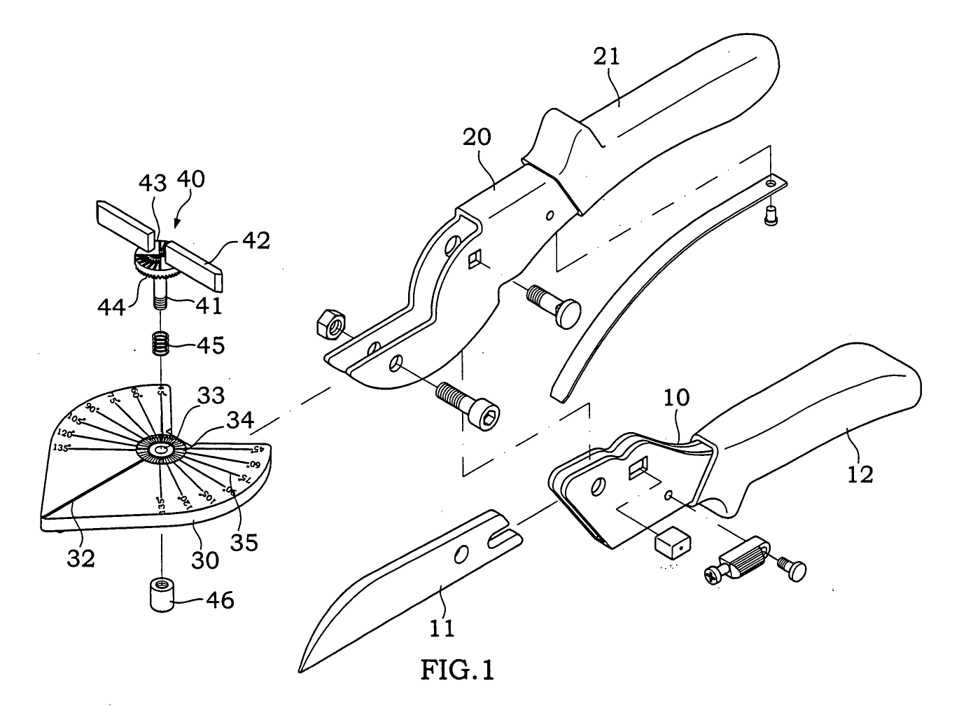

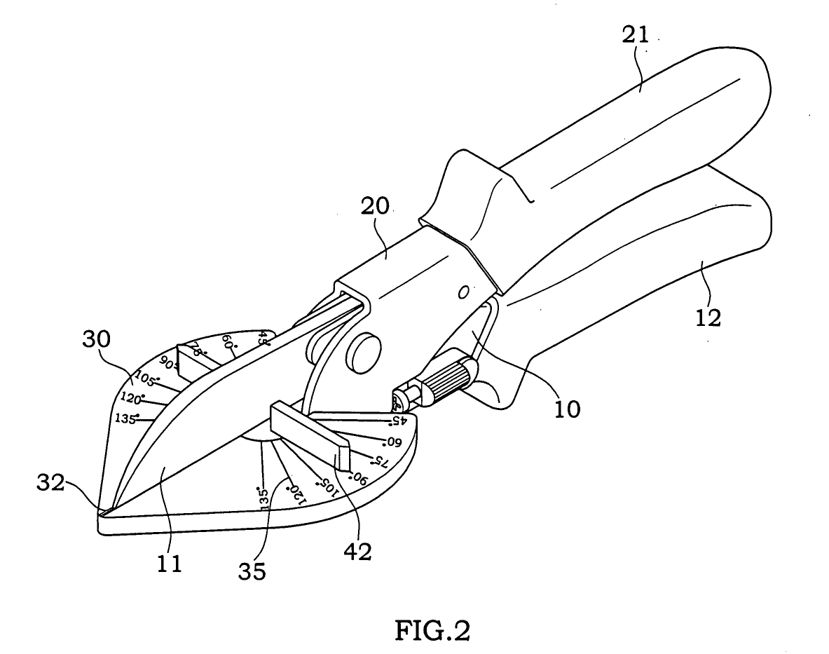

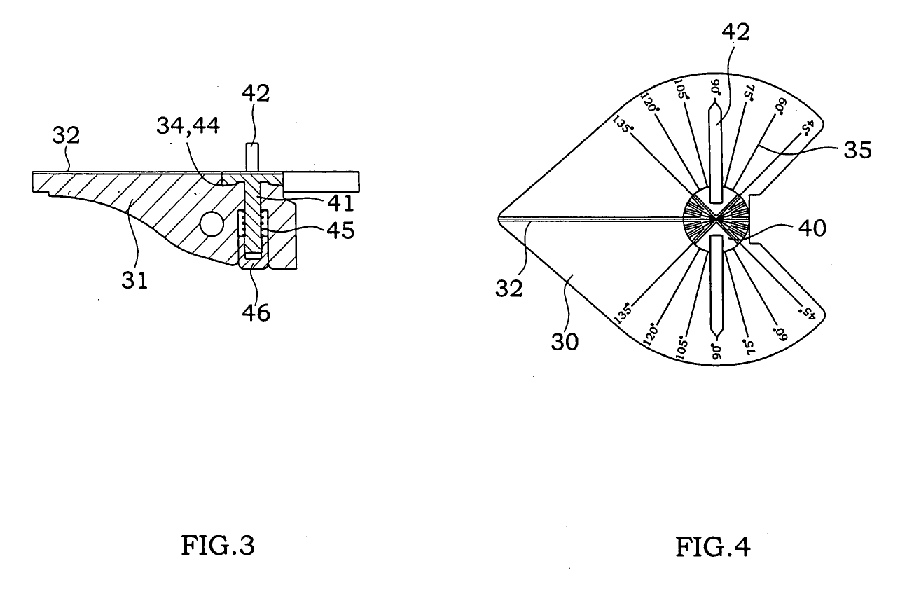

Please refer to FIGS. 1 and 4 for the scissors with adjustable cutting sectional angle, which comprises a first limb 10, and the first limb 10 has a blade 11 at its front end; a second limb 20, and the second limb 20 is pivotally coupled with the first limb 10 and capable of being elastically extended or engaged; a handle section 12, 21 disposed individually at a rear end of the first limb 10 and the second limb 20 for a user to hold the scissors; a rotary disc base 30 having a support section 31 disposed at its bottom for fixing the front end of the second limb 20, and a cutting channel 32 disposed along a central line of the rotary disc base 30 at a position corresponding to the blade 11, so that the blade can be used for cutting a work piece; an axle hole 33 disposed on the cutting channel 32 at a position proximate to the pivotal connection of the limbs 12, 21, and a positioning gear 34 disposed at the periphery of the top of the axle hole 33; wherein the rotary disc base 30 has a plurality of calibrations 35 disposed on the top surface with the axle hole 33 as the center; a rotary axle 40 having an axle 41 that passes through the axle hole 33, and two corresponding blocking brackets 42 protruded from the top of the rotary axle 40, and a through channel 43 disposed at the center of the two blocking brackets 42 for allowing the blade 11 to pass through; wherein a plurality of engaging serrations 44 is protruded from the bottom of the rotary disc axle 40 at a position corresponding to the positioning gear 34, and a spring 45 is disposed on the axle 41, and a screw nut 46 is secured at the rear end of the axle 41 for the positioning, such that the engaging serrations 44 can be elastically engaged onto the positioning gear 34 under normal conditions.

A user may put a work piece on the rotary disc base 30 and push it all the way to the blocking bracket 42, and then apply a gripping force to the first limb 10 and the second limb 20 to drive the blade 11 to cut along the through channel 43 and press against the interior of the cutting channel 32 in order to complete the task of cutting the work piece.

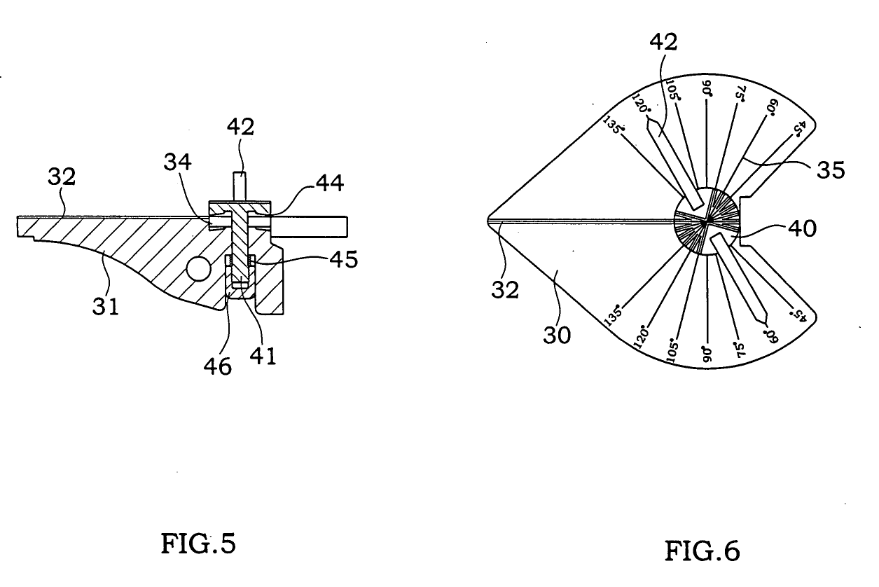

Please refer to FIG. 5 again. When a user needs to cut the work piece at different angles, the user can apply a force onto the rotary disc axle 40, such that the engaging serrations 44 separate from the positioning gear 34 due to the resilience of the spring 45 and then rotate the rotary axle 40 to adjust the intersecting angle of the blocking bracket 42 and the blade 11 as shown in FIG. 6 in order to control the angle of cutting the work piece. With such arrangeinent, the user can push the work piece all the way to the blocking bracket 42 and apply a gripping force onto the first limb 10 and the second limb 20 to drive the blade to cut into the through channel 43 and produce a shear onto the work piece, and thus easily providing the required cutting angle for the work piece.

In the present invention, the movement of rotating the rotary disc axle can directly adjust the angle between the blocking bracket 42 and blade 11 without using any other measuring tools to directly control and adjust the angle of cutting the work piece. If it is necessary to cut a large quantity of work pieces with the same angle, then the user just needs to adjust the angle of the rotary disc axle 10 in advance to easily and quickly complete the cutting task for a large quantity of work pieces.

In summation of the description above, the present invention overcomes the shortcomings of the prior-art and enhances the performance than the conventional structure and further complies with the patent application requirements and is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements.

1. A pair of scissors with adjustable cutting sectional angle, comprising:
a first limb and a second limb, being pivotally coupled with each other and capable of being selectively and elastically extended and engaged, and said first limb having a blade at its front end, and said scissors further comprising:
a rotary disc base, being disposed at a front end of said second limb for cutting a work piece; and
a rotary disc axle, being disposed along a central line of said rotary disc base and having two blocking brackets protruded from the top of said rotary disc axle and a through channel disposed in the middle of said two blocking brackets for allowing said blade to pass through;
thereby, a user rotates said rotary disc axle and adjusts the angle between said blocking bracket and said blade to control the angle of cutting said work piece.

2. The pair of scissors with adjustable cutting sectional angle of claim 1, wherein said rotary disc base comprises an axle hole for pivotally coupling said rotary disc axle.

3. The pair of scissors with adjustable cutting sectional angle of claim 2, wherein said rotary disc base comprises a positioning gear at the periphery of said axle hole of said rotary disc base.

4. The pair of scissors with adjustable cutting sectional angle of claim 3, wherein said rotary disc axle comprises a plurality of engaging serrations protruded on the bottom of said rotary disc axle at a position corresponding to said positioning gear.

5. The pair of scissors with adjustable cutting sectional angle of claim 1, wherein said rotary disc axle comprises a spring such that said engaging serrations elastically engages with said positioning gear under normal conditions.
